(19) United States
(12) Patent Application Publication
(10) Pub. No.: US 2026/0244933 A1
(43) Pub. Date: Aug. 20, 2026

(54) SYSTEM AND METHOD FOR GENERATING CUSTOM LARGE LANGUAGE MODEL EMBEDDINGS USING AN EMBEDDING TRANSFORMATION MODEL

(71) Applicants: Constructor Technology AG, Schaffhausen (CH); Constructor Education and Research Genossenschaft, Schaffhausen (CH)

(72) Inventors: Alexander TORMASOV, Busingen am Hochrhein (DE); Sergey ULASEN, Singapore (SG); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 19/057,292

(22) Filed: Feb. 19, 2025

(51) Int. Cl. G06N 3/0895

(52) U.S. Cl. CPC G06N 3/0895

(57) ABSTRACT

Disclosed herein are systems and methods for generating LLM embeddings. The method includes receiving an input query to a LLM service. The method also includes receiving an input query to a LLM service; determining if a main embedding of the query is provided by a main embedding model; based on a determination that the main embedding of the input query is not provided by the main embedding model, generating a secondary embedding of the query by a pre-trained fallback embedding model, and applying an embedding transformation model to the secondary embedding to predict the main embedding and transmitting the predicted main embedding to the LLM service.

### FIELD OF TECHNOLOGY

The present disclosure relates to the field of machine learning models (MLMs), and, more specifically, to systems and methods for generating large language model (LLM) embeddings using an embedding transformation model.

### BACKGROUND

Embedding models are utilized by LLMs to provide a foundational way to represent language in a dense, continuous, and semantically rich vector space. These embeddings encode the relationships between words, phrases, or even entire documents, enabling LLMs to capture the nuances of meaning and context. By transforming discrete linguistic elements into mathematical representations, embedding models allow LLMs to perform complex tasks like understanding synonyms, polysemy, and contextual variations efficiently.

Accordingly, when a main embedding model becomes temporarily unavailable, several issues can arise that can disrupt operations and degrade user experiences. Services relying on real-time processing, such as search engines, recommendation systems, or chatbots, may experience downtime or functionality loss, leading to slower responses or irrelevant results. Batch processes for generating or updating embeddings can face delays, creating data backlogs and inconsistencies. In some cases, systems may switch to fallback methods, which are often less effective, resulting in a noticeable drop in quality. This can frustrate users and harm their trust, potentially leading to revenue losses, especially for customer-facing applications. Additionally, downstream systems dependent on embeddings might fail, causing cascading issues. Operational costs can also increase as teams work to troubleshoot or implement temporary fixes. To mitigate these risks, strategies like caching frequently used embeddings, deploying backup models, monitoring system health, and designing robust fallback mechanisms can help ensure continuity and maintain user satisfaction.

### SUMMARY

To address the shortcomings when a main embedding model becomes temporarily down or unavailable, the present disclosure describes a system and method for generating LLM embeddings using a fallback embedding model and using an embedding transformation model to predict embeddings for the main embedding model. Some of the technical improvements of the technical disclosure is increased system reliability since continuous operation ensures that the system continues functioning even when the main embedding model is unavailable, avoiding complete service disruption. Another technical improvement is reduced downtime impact as users or downstream processes experience minimal interruption due to the pre-trained fallback embedding model and embedding transformation model handling embedding generation as a backup or temporary measure.

Yet another technical improvement of the present disclosure is that the embedding transformation model may be implemented to transform high-dimensionality embeddings to low-dimensionality embeddings and vice versa. This is useful in reducing dimensionality of data for computational efficiency or expanding dimensionality for detailed analysis. In particular, the embedding transformation model helps with fault tolerance since reducing dimensionality can help in simplifying the data representation, making it more robust to noise or error. In addition, the embedding transformation model also provides more flexibility in the system due to the ability to operate in both directions (e.g., high-to-low and low-to-high) offering versatility in data processing. The ability to transform back to high-dimensional embeddings also ensures that minimal information is lost in the process. By integrating the embedding transformation model, organizations ensure their embedding-dependent systems remain robust, user-focused, and cost-efficient, even in challenging situations.

In one exemplary aspect, a method generating LLM embeddings is disclosed. The method comprises: receiving an input query to a LLM service; determining if a main embedding of the query is provided by a main embedding model; based on a determination that the main embedding of the input query is not provided by the main embedding model, generating a secondary embedding of the query by a pre-trained fallback embedding model, and applying an embedding transformation model to the secondary embedding to predict the main embedding and transmitting the predicted main embedding to the LLM service.

In some aspects, the techniques described herein relate to a method, wherein the pre-trained fallback embedding model comprises more complex parameters and embedding size than the main embedding model.

In some aspects, the techniques described herein relate to a method, wherein a size of an input of the embedding transformation model is a same size as an output of the pre-trained fallback embedding model.

In some aspects, the techniques described herein relate to a method, wherein a size of an output of the embedding transformation model is a same size as an output of the main embedding model.

In some aspects, the techniques described herein relate to a method, wherein the pre-trained fallback embeddings model is pre-trained on a similar type of data as the main embedding model.

In some aspects, the techniques described herein relate to a method, further comprising determining a category of a subject matter of the input query; and selecting, out of a plurality of fallback embedding models, a model pre-trained on data associated with the determined category of the subject matter of the input query.

In some aspects, the techniques described herein relate to a method, wherein the main and secondary embeddings have different dimensionality.

In some aspects, the techniques described herein relate to a method, further comprising providing a plurality of fallback embedding models pre-trained on different types of data, wherein the different types of data correspond to different category of subject matter.

In some aspects, the techniques described herein relate to a method, wherein the pre-trained fallback embedding model is deployed on a client and the embedding transformation model is deployed on a server.

According to one aspect of the disclosure, a system is provided for generating LLM embeddings is disclosed, the system including: at least one memory; and at least one hardware processor coupled with the at least one memory and configured, individually or in combination, to: receive an input query to a LLM service; determine if a main embedding of the query is provided by a main embedding model; based on a determination that the main embedding of the input query is not provided by the main embedding model, generate a secondary embedding of the query by a pre-trained fallback embedding model, and apply an embedding transformation model to the secondary embedding to predict the main embedding and transmitting the predicted main embedding to the LLM service.

In one exemplary aspect, a non-transitory computer-readable medium is provided for generating LLM embeddings, including instructions for: receiving an input query to a LLM service; determining if a main embedding of the query is provided by a main embedding model; based on a determination that the main embedding of the input query is not provided by the main embedding model, generating a secondary embedding of the query by a pre-trained fallback embedding model, and applying an embedding transformation model to the secondary embedding to predict the main embedding and transmitting the predicted main embedding to the LLM service.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram of a system for generating LLM embeddings for a LLM service according to aspects of the present disclosure.

FIG. 2 is a block diagram illustrating a system for executing a main embedding model and a pre-trained trained fallback model while training the embedding transformation model according to aspects of the present disclosure.

FIG. 3 is a block diagram illustrating a system for executing the pre-trained fallback model and embedding transformation model to predict main embeddings when the main embedding model is unavailable according to aspects of the present disclosure.

FIG. 4 is an example method of for generating LLM embeddings according to aspects of the present disclosure.

FIG. 5 presents an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for predicting Large Language Model (LLM) embeddings using an embedding transformation model. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

LLM embeddings leverage dense vector representations to capture semantic relationships between words, phrases, or entire texts. These embeddings can be clustered to group similar concepts, allowing for efficient organization and retrieval of information. One of the key advantages of embedding models is their ability to reduce the dimensionality of language data while preserving its semantic structure. Traditional representations, like one-hot encodings, are sparse and computationally expensive, offering no insight into the relationships between different words. In contrast, embeddings cluster semantically similar items closer together, enabling LLMs to generalize and infer relationships across vast datasets. This compact representation not only saves computational resources but also enhances the model's ability to learn patterns and context effectively.

The key features of embeddings are dimensionality reduction, semantic similarity, and efficiency. The embeddings map high-dimensional data (e.g., sparse word counts, pixels) into lower-dimensional space, preserving important features. Semantic similarity refers to having similar items being closer in the semantic space. Embeddings enable efficient computation for downstream tasks (e.g., clustering, classification). Simply put, embedding models are foundational in modern artificial intelligence (AI), transforming raw data into structured representations that facilitate a wide range of machine learning tasks.

Embedding models also play a pivotal role in enabling LLMs to handle a wide range of tasks. For instance, embeddings empower LLMs to perform semantic search, recommendation, and clustering by leveraging vector similarity measures. They are equally indispensable for cross-lingual and multimodal applications, aligning language with other modalities like images or audio in a shared vector space. Pre-trained embeddings further accelerate model training and transfer learning, providing a strong baseline of linguistic knowledge that can be fine-tuned for specific applications or domains. Pre-trained models are ready for immediate use, eliminating the need for extensive training from scratch, which can save significant time and resources.

However, some LLM models may have different embedding dimensionalities because they are designed for varying tasks, architectures, or resource constraints. For example, models optimized for general-purpose tasks may use high-dimensional embeddings to capture nuanced contextual relationships, while smaller, task-specific models use lower-dimensional embeddings for efficiency. This discrepancy in dimensionality can be problematic when integrating multiple models or embeddings into a single system, as mismatched dimensions prevent direct comparison, combination, or processing. Resolving these differences often requires computationally expensive transformations or alignment techniques, which can introduce inefficiencies, increase latency, and risk losing important information during dimensionality reduction.

Accordingly, the present disclosure describes implementing an embedding transformation model for transforming high-dimensionality to low-dimensionality, and vice versa. The ability to transform high-dimensional embeddings to low-dimensional embeddings (and vice versa) is crucial for LLM services as it enhances computational efficiency, scalability, and task adaptability. High-dimensional embeddings capture complex contextual information but are resource-intensive, while low-dimensional embeddings reduce computational overhead, making them suitable for quick tasks like clustering, similarity searches, or classification. This transformation also helps preserve essential information, filter out noise, and optimize storage and transmission, especially in distributed architectures where minimizing latency and bandwidth is critical. The bidirectional flexibility allows LLMs to perform diverse tasks—using low-dimensional embeddings for efficient processing and switching to high-dimensional embeddings for context-rich output generation, such as detailed responses or machine translations. Additionally, fault tolerance improves as low-dimensional representations are more robust to noise, and scalability is enhanced by enabling large-scale batch or parallel processing. These transformations are especially valuable in multi-lingual and cross-modal systems, aligning data across different languages or modalities within a shared embedding space. Overall, this capability balances speed, precision, and versatility, making it essential for delivering efficient and user-friendly LLM services.

Turning now to the figures, example aspects are depicted with reference to one or more components described herein, where components in dashed lines may be optional.

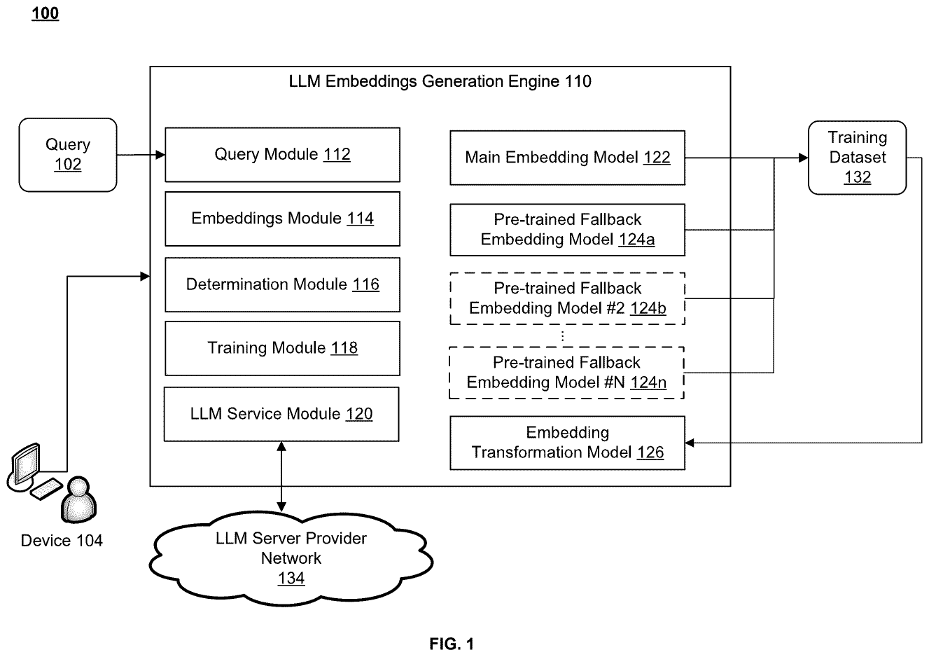

FIG. 1 is a block diagram of a system 100 for generating LLM embeddings for a LLM service according to aspects of the present disclosure. Generally, user A of computer system 104 creates a query 102 to the LLM service provider 134. The query 102 is passed to the LLM embeddings generation engine 110 that may be deployed on a network server (not shown). The LLM embeddings generation engine 110 generates embedding(s) for the query 102 and passes the embedding(s) to the LLM service provider 134 for processing. The LLM service provider 134 then performs inference on the received embedding(s) and returns a response to the user A.

In one aspect, the LLM embeddings generation engine 110 executes a main embedding model configured to generate low dimensionality of embeddings, execute a pre-trained fallback embedding model configured to generate embeddings of a different dimensionality (e.g., higher or lower dimensionality than the main embedding model) than the main embedding model, and implement an embedding transformation model configured to transform the high-dimensionality embeddings to a low-dimensionality embeddings or vice versa. Generally, the LLM embeddings generation engine 110 is configured to prepare the embedding transformation model and using the embedding transformation model 128 to predict LLM embeddings of the main embedding model 122 when the main embedding model 122 is not accessible.

Embedding models are powerful tools for generating vector representations of textual, visual, or multimodal data. These models map inputs (e.g., text, images, or other data types) into dense, fixed-dimensional vectors in a high-dimensional space. The resulting embeddings capture semantic or contextual relationships, enabling efficient similarity comparisons, clustering, and information retrieval. For example, text embeddings generated from embedding models may be used to find semantically similar sentences, enhance search algorithms, or classify documents based on their content. Their versatility makes them fundamental in applications like recommendation systems, natural language processing tasks, and large-scale data analysis. As an example, the LLM embeddings generation engine 110 may be hosted on a cloud server or allocated at a local device (e.g., such as the computer system 104).

In one aspect, the system 100 may include at least user's A computer system 104, a LLM embeddings generation engine 110, a training dataset 132, and a LLM service provider 134. The LLM service provider 134 is a system of interconnected resources and platforms designed to deliver LLM-based capabilities to users and businesses. It typically includes cloud infrastructure for hosting and running the models, application programming interfaces (APIs) for seamless integration with various applications, and tools for fine-tuning and customizing models to specific use cases. These networks often support scalability, allowing users to process massive data or handle spikes in demand. By leveraging distributed computing and optimization techniques, the network ensures efficient delivery of advanced language understanding, generation, and interaction capabilities to a wide range of industries, from customer support to content creation.

In some aspects, the LLM embeddings generation engine 110 may include a query module 112, an embeddings module 114, a determination module 116, a training module 118, a LLM service module 120, a main embedding model 122, at least one pre-trained fallback embedding model 124a, and an embedding transformation model 126.

The LLM embeddings generation engine 110 is configured to prepare the embedding transformation model 126 based on a training dataset 132 comprising respective embeddings from the main embedding model 122 and a pre-trained fallback embedding model 124a and the query 102. This provides a way for the pre-trained fallback embedding model 124a and the embedding transformation model 126 to predict a main embedding for the main embedding model 122 when the main embedding model 122 is unavailable.

The main embedding model 122 may be a type of machine learning model (MLM), often used in natural language processing (NLP) and other domains, which performs embedding generation by transforming data (e.g., text, images, or graphs) into a continuous vector space. These vectors (e.g., embeddings) represent the essential characteristics of the input data in a way that preserves semantic or structural relationships. The main goal of an embedding model is to make data more accessible for computation and analysis by encoding it into a numerical format that machine learning algorithms can work with.

Embedding models are widely used to represent data in dense vector spaces for various machine learning tasks. In some aspects, the main embedding model may be a commercial embedding model that generates high dimensionality embeddings. Examples of embedding models include GPT-based models, such as OpenAI's text-embedding-ada-002, which provides embeddings with a dimensionality of 1536, optimized for tasks like semantic search and similarity matching. Similarly, BERT-based models, like Sentence-BERT (SBERT), generate embeddings with dimensionality ranging from 768 for base versions to higher dimensions in larger variants, suitable for sentence-level tasks. Low-dimensional embeddings, such as those from Word 2Vec, typically range from 100 to 300 dimensions, making them efficient for simpler NLP tasks where memory and speed are critical. In contrast, high-dimensional embeddings like GPT-3, which outputs embeddings with a dimensionality of 12288, capture rich contextual information but require significantly more computational resources. These varying dimensions illustrate the trade-offs between simplicity, efficiency, and representational power in embedding models.

The main embedding model 122 works by transforming a query 102 containing raw input data (e.g., text, images, or other high-dimensional information) into a compact numerical representation in a continuous vector space. This transformation captures the semantic, syntactic, or structural relationships within the data, making it more interpretable and usable for downstream tasks. For example, in natural language processing, an embedding model maps words or sentences to dense vectors where similar meanings are closer in the vector space. The model typically leverages deep learning architectures, such as neural networks, trained on large datasets to learn these relationships. Through this process, it extracts and encodes essential features while discarding irrelevant noise, enabling efficient and meaningful comparisons, clustering, or feeding into machine learning models for tasks like classification, recommendation, or search. The main embedding model 122 serves as the core mechanism that bridges raw data and machine learning pipelines, ensuring the system understands and processes the input effectively.

The pre-trained fallback embedding model 124a may be a type of MLM model with different dimensions than the main embedding model 122 that operates as a complementary mechanism to maintain system functionality when the main embedding model 122 encounters limitations. Specifically, the pre-trained fallback embedding model 124a may generate secondary embeddings when the main embedding model 124 is unavailable (e.g., being offline due to network issues, maintenance/repairs/updating, or cyberattack), fails to produce a result, or encounters issues like high latency or errors. The pre-trained fallback embedding model 124a is a pre-trained fallback embedding model that generates embeddings of different dimensionality (e.g., higher dimensionality or lower dimensionality) than the main embedding model 124.

Although the pre-trained fallback embedding model 124a may differ in dimensionality or vendor-specific architectures from the main embedding model 122, their similarity lies in being trained on related data categories or contexts or the same language corpus. This shared domain of training ensures that both models capture overlapping semantic structures, albeit at varying levels of granularity or abstraction due to differences in architecture or embedding size. When employed, the pre-trained fallback embedding model 124a provides embeddings that, despite dimensional discrepancies, can be aligned or adapted using transformation techniques to fit the system's requirements. This adaptability ensures the fallback model bridges gaps, such as out-of-vocabulary inputs or domain mismatches, while leveraging its shared contextual understanding with the main embedding model 122 to deliver consistent and meaningful representations.

The pre-trained fallback embedding model 124a and the main embedding model 122 may be similar such that the main embedding model 122 and the pre-trained fallback embedding model 124a are trained on a similar category of data (e.g., trained on 19^{th} century English poetry) or trained on a similar language, but from different vendors. In this way, the pre-trained fallback embedding model 124a should be “similar” to the main embedding model. For example, if the main embedding model is a generic model then the pre-trained fallback embedding model should be generic. As another example, if the main embedding model is a specialized model (e.g., language, subject matter), then a similar specialized fallback embedding model should be selected by the determination module 116. In some aspects, the pre-trained fallback embedding model may be a generic model that is deployed on a client side.

The pre-trained fallback embedding model 124a is developed through a pre-training process on a large and diverse dataset that aligns with the intended domain or task. For example, if pre-trained fallback embedding model 124a is designed for English poetry of the 19th century, the training corpus would include extensive collections of text from poets of that era, ensuring the model captures the unique syntactic, semantic, and stylistic features inherent to the data. The pretraining involves leveraging machine learning techniques, often using deep neural networks like transformers or recurrent architectures, to learn the relationships between words, phrases, or other data units. This process typically employs unsupervised or self-supervised learning, where objectives like predicting masked words, next-token prediction, or context modeling are used to encode rich contextual information into dense vector embeddings. Additionally, vendor-specific optimizations, such as hyperparameter tuning or domain-specific preprocessing, refine the model's ability to generalize across tasks within its domain. This pretraining enables the pre-trained fallback embedding model 124a to generate meaningful representations even when deployed in unfamiliar contexts or when faced with dimensional differences relative to the main embedding model 122.

The embedding transformation model 126 may be a MLM for transforming high-dimensionality embeddings to low-dimensionality embeddings and vice versa. In some aspects, the embedding transformation model 126 corresponds to an auto-encoder. Auto-encoders work by encoding input data into a compact, lower-dimensional latent space through an encoder network and then reconstructing the original data through a decoder network, thereby learning efficient representations. This process not only enables dimensionality reduction but also helps preserve the essential features of the data. The embedding transformation model 126 can dynamically switch between compressing data for computational efficiency and reconstructing it for detailed analysis, depending on the task. Furthermore, the model's deployment on a cloud-based or server-hosted solution ensures scalability and accessibility, enabling it to handle large-scale data transformation tasks with high performance and reliability across diverse applications.

The embedding transformation model 126 provides several benefits and functionalities that enhance the efficiency and versatility of machine learning systems.

First, the embedding transformation model 126 helps with dimensionality management. For example, the embedding transformation model 126 transforms high-dimensional embeddings into lower-dimensional ones, reducing computational and storage costs while retaining essential information and converts low-dimensional data back into high-dimensional spaces when detailed or enriched data representations are needed.

Second, the embedding transformation model 126 improves computational efficiency of the system. By reducing dimensionality, the embedding transformation model 126 significantly decreases the computational burden on systems, improving the speed of downstream processes like clustering, classification, or similarity searches. Lower-dimensional data is more efficient to process, transmit, and store, optimizing resource usage, especially in large-scale or real-time applications.

Third, the embedding transformation model 126 improves flexibility and adaptability of the system. For example, its ability to operate bidirectionally (reduce and expand embeddings) ensures adaptability across tasks requiring different levels of detail or precision. In addition, the embedding transformation model 126 can be applied in various domains, including text, images, and other high-dimensional data types, due to its general-purpose nature. In addition, the embedding transformation model 126 bridges compatibility issues between embeddings of different dimensions or vendors, ensuring interoperability and making it easier to integrate various components of a system.

Fourth, the embedding transformation model 126 offers robust feature preservation by leveraging architectures like auto-encoders, the embedding transformation model 126 ensures that important features and relationships within the data are preserved during transformation, minimizing information loss. By tailoring data representation to the specific needs of different algorithms, the embedding transformation model 126 improves the accuracy and efficiency of tasks such as recommendation, semantic search, or anomaly detection. It addresses the “curse of dimensionality,” which can degrade the performance of machine learning models on high-dimensional data.

Fifth, the embedding transformation model 126 enables scalability via cloud deployment. Hosting the embedding transformation model 126 on a cloud-based or server-hosted solution allows it to scale seamlessly, enabling it to handle vast datasets or serve multiple clients simultaneously. Remote deployment also ensures accessibility and integration into distributed systems or applications.

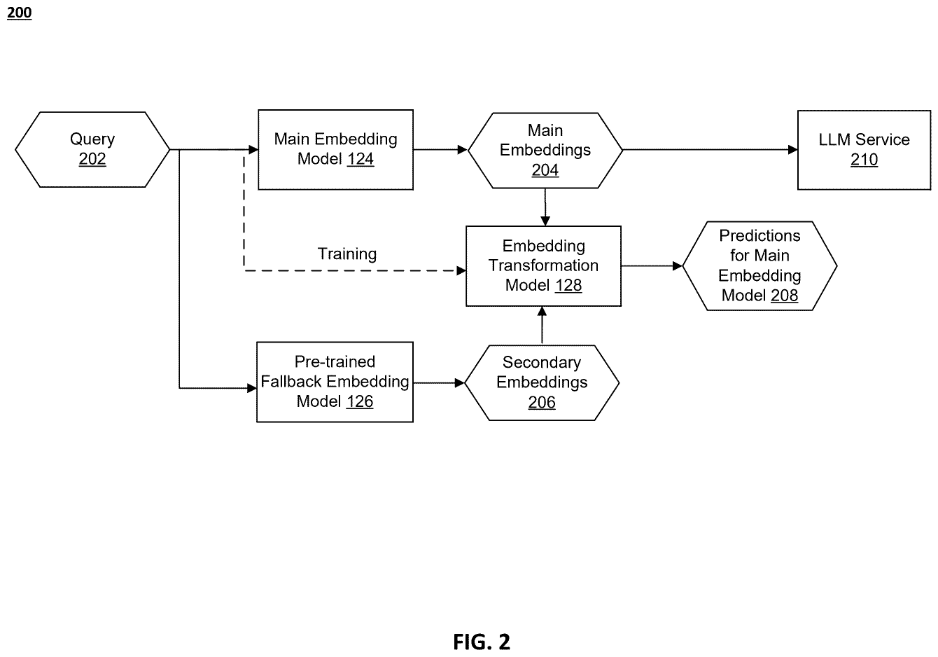

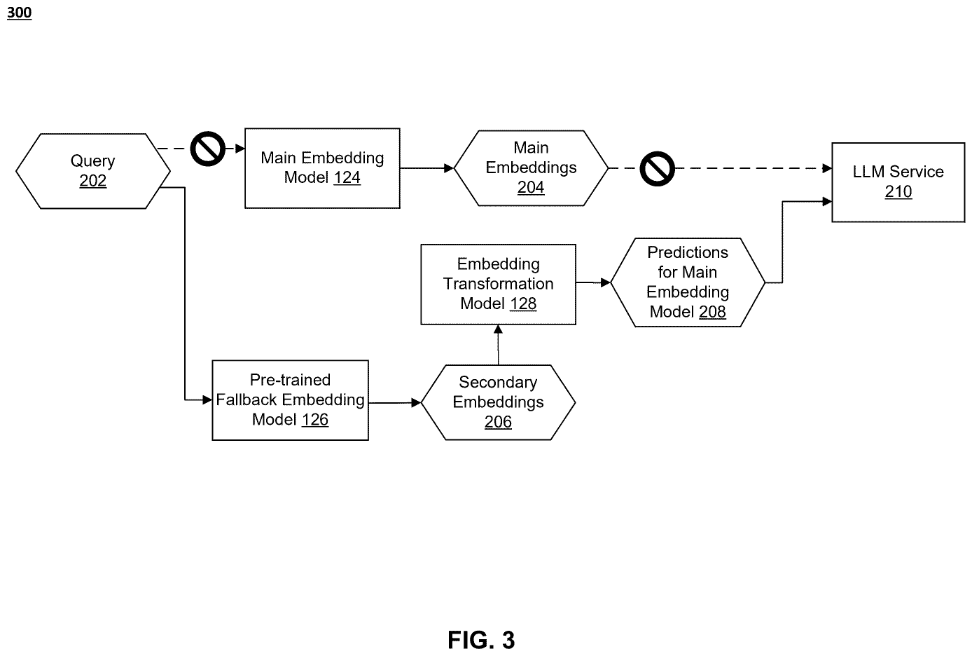

The LLM embeddings generation engine 110 may also execute a query module 112 configured to obtain a query (e.g., query 202 from FIG. 2, query 202 from FIG. 3) from a computer system 104 of a user. Generally, the query module 112 is configured to act as an intermediary layer in LLM-based systems by enhancing a LLM model's ability to understand, interpret, and respond to user queries effectively. Specifically, the query module 112 may be configured to handle and interpret the query and generate a prompt from the query that is formatted in a way that a LLM from the LLM service provider 134 can process. The primary role of the query module 112 is to bridge the gap between raw user input from the computer system 104 and the LLM service provider 134. In some aspects, the query module 112 may be equipped with natural language understanding for analyzing and interpreting the query to understand its intent, context, and meaning.

In some aspects, the query module 112 may implement a UI for display on the computer system 104 that is configured to receive user input (e.g., user queries) and displaying LLM answers. As an example, a user may use the computer system 104 to enter the query for input as a prompt into the LLM. In some aspects, the query module 112 may prepare the query as a prompt for input into the LLM on the LLM service provider 134 by cleaning and normalizing the text. As an non-limiting example, this may involve: removing unnecessary punctuations, special characters, or stop words; correcting spelling or grammatical errors; or converting different forms of data (e.g., dates, numbers, or units) into a standardized format. By identifying the user's intent behind the query (e.g., asking a question, requesting information, or performing a task), the query module 112 ensure that the LLM from the LLM service provider 134 may determine the appropriate type of response or action.

The LLM embeddings generation engine 110 may execute a embeddings module 114 configured to generate main embeddings by the main embedding model 122 and/or generate secondary embeddings by the pre-trained fallback embedding model 124a based on an input query 102. As mentioned above, generating embeddings based on the input query 102 is crucial for leveraging LLMs because embeddings distill semantic meaning into high-dimensional vector space, enabling efficient information retrieval and contextual understanding. These embeddings allow the embedding models to compare, classify, and rank related concepts with precision, bridging gaps in natural language nuances. By encoding the input query 102, embeddings facilitate tasks like document similarity, personalized recommendations, or fine-tuning workflows, enhancing the model's adaptability to user intent and improving overall performance across diverse applications.

In some aspects, the LLM embeddings generation engine 110 may execute the embeddings module 114 to identify a subject matter, language in data set, or dimensionality corresponding to the input query 102 and select one of a respective pre-trained fallback embedding models 124a, 124b, 124n associated with the subject matter. In particular, the computer system 104 executes the embeddings module 114 to analyze the input query 102, transforming it into a numerical vector representation (or embedding) that captures its semantic meaning. This analyze enables the system 100 to identify the subject matter or domain of the input query 102 (e.g., healthcare, finance, or technology). The system 100 is equipped with multiple pre-trained fallback embedding models 124a, 124b, . . . 124n, each specialized for a specific domain and optimized to handle queries within their respective subject areas.

Accordingly, once the subject matter, language in dataset, or dimensionality from the input query 102 is determined, the system 100 selects the most relevant pre-trained fallback embedding model to process the input query 102, ensuring accurate and contextually appropriate results. This modular design allows for scalability, as new domain-specific pre-trained fallback embedding models can be added or updated without overhauling the entire system 100. Additionally, using specialized pre-trained fallback embedding models 124a, 124b, 124n improves efficiency and performance by focusing computational resources on the most relevant domain. The fallback nature of these models adds robustness, enabling the system to handle diverse queries effectively, even in dynamic or evolving environments. This approach is particularly valuable for applications such as search engines, customer support systems, AI assistants, and content recommendation platforms, where context-sensitive and domain-specific responses are essential.

The LLM embeddings generation engine 110 may execute a determination module 116 configured to determine if a primary embedding of the input query 102 is provided by the main embedding model 122. The determination module 116 checks if the main embedding model 122 may generate a main embedding for the input query 102. If the determination module 116 determines that the main embedding model 122 is unavailable or cannot provide a main embedding for the input query 102, then the system 100 can redirect the input query 102 to alternative mechanisms, such as the pre-trained fallback embedding models 124a, 124b, 124n. The fallback mechanism ensures robustness and adaptability in handing input queries. By determining the suitability of the main embedding model 122 before proceeding, the system 100 avoids wasting computational resources on embeddings that are not useful or relevant. This optimization improves system efficiency, especially in large-scale applications with high query volumes. This contributes to the overall reliability of the system 100, ensuring that queries are always processed using the most appropriate method.

The LLM embeddings generation engine 110 may execute a training module 118 configured to prepare (e.g., train) the embedding transformation model 126 by obtaining a training dataset 132 including at least the primary embeddings generated by the main embedding model 122, the secondary embeddings generated by the pre-trained fallback embedding model, and the input query 102 and training the embedding transformation model 126 to predict the primary embeddings based on the secondary embeddings.

The LLM embeddings generation engine 110 may execute the LLM service module 120 configured to interact with the LLM service provider 134 by transmitting embeddings generated by the main embedding model 122 and/or embedding transformation model 126 for input into the LLM from the LLM service provider 134 and to obtain responses from the LLM service provider 134. Generally, the LLM service module 120 is responsible for managing the interactions between the LLM service provider 134 and modules from the LLM embeddings generation engine 110. The primary function of the LLM service module 120 is to handle the exchange of data between the LLM embeddings generation engine 110 and the LLM service provider 134 to ensure that the inputs and output of the LLM are effectively communicated to the appropriate destinations. This module serves as the interface layer that facilitates communication to enable the LLM service module 120 to integrate into the system 100.

In some aspects, the LLM service module 120 is configured to provide an API that the LLM embeddings generation engine 110 utilizes to interact with the LLM service provider 134. As a non-limiting example, this may include handling API requests and responses from the LLM service provider 134, managing authentication and authorization for secure access, or supporting different API protocols (e.g., REST, WebSocket) to accommodate various integration needs.

In some aspects, the LLM service module 120 may be configured to integrate with internal and/or external systems and databases such as the training dataset 132. This may involve fetching additional data needed to answer a query or enabling bidirectional communication between the LLM service module 120 and external systems (e.g., CRM software, knowledge bases, or real-time data feeds).

It should be noted that the generation of embeddings of the main embedding model 122 and/or the pre-trained fallback embedding models 124a, 124b, 124n and the implementation and preparation of the embedding transformation model 126 described in the present disclosure are heavily simplified. One skilled in the art will appreciate that the embedding models utilized may have significantly large datasets with highly specific details. This type of analysis would be beyond the capabilities of the human mind because the amount of data to be identified, considered, and processed is unfathomable.

FIG. 2 is a block diagram illustrating a normal mode of operation of system 100 in which a main embedding model is accessible to provide main embeddings for user's queries, the fallback model generates corresponding secondary embeddings, while the embedding transformation model is being trained on the main and secondary embeddings according to aspects of the present disclosure.

Generally, when using embedding techniques for information retrieval, embeddings are created for queries-the queries (e.g., any form of text input including documents, images, audio, video, etc.) are embedded beforehand to build a searchable index, while the query 202 is then converted into an embedding to compare against the query embeddings and to find the most relevant results based on semantic similarity. When a user submits an input query 202, it is converted into an embedding vector to facilitate comparison with other query embeddings.

As shown in system 200, a main embedding model 124 (e.g., the main embedding model 124 shown in FIG. 1) processes the input query 202 (e.g., a few words, a sentence, a paragraph or a document) to generate a main embeddings 204 of the input query 202. The main embedding model 124 may be any commercial embedding training model that generates low dimensionality of embeddings. In some aspects, the main embedding model 124 can be a machine learning model or an algorithm. In some aspects, the main embedding model 124 is provided by or associated with the LLM service 210 and provides embeddings in a “native” dimensionality of the LLM. “Native” dimensionality implies that the embedding vectors produced by the LLM model matches the dimensional requirements or preferences of the associated LLM service 210. Using the native dimensionality ensures optimal performance as the embeddings are tailored to work seamlessly with the LLM without the need for additional transformations or dimensionality reductions.

Specifically, the main embedding model 124 processes the input query 202 by transforming its content into a dense numerical representation (e.g., embeddings) within a high-dimensional vector space. This transformation captures semantic relationships between words, phases, or entire sections of the input query 202. The main embedding model 124 typically tokenizes the text into smaller components, such as words or sub-words, and maps these to vectors using learned parameters. By aggregating these vectors, the main embedding model 124 creates a holistic embedding for the input query 202 that encodes its meaning, context, and structure. These embeddings can then be used for downstream tasks such as inference, dictionary building, similarity comparison and clustering.

The LLM from a LLM service 210 then uses the main embeddings 204 from the main embedding model 124 as a foundational mechanism to understand and process textual data effectively. The main embeddings 204, which are dense numerical vectors representing words, phrases, or entire documents, serve as a encoding that captures the semantic meaning and contextual relationships in the queries 202. In particular, the LLM service 210 uses main embeddings 204 to perform inference and respond to the queries 202. The main embeddings 204 also help group similar texts or classify them into predefined categories based on their proximity in the embedding space.

The pre-trained fallback embedding model 124a also processes the input query 202 to generate secondary embeddings 206 of the input query 102. The pre-trained fallback embedding model 124a is configured to generate embeddings of a different dimensionality (e.g., higher dimensionality or lower dimensionality) than the main embedding model 124. In some aspects, the pre-trained fallback embedding model 124a may correspond to a type of advanced machine learning model developed by Google DeepMind or a custom embedding model. These models integrate LLMs with multimodal capabilities, enabling them to handle and generate data across various modalities, such as text, images, videos, and potentially other data types. As mentioned above in FIG. 1, the main embedding model 122 and the pre-trained fallback embedding model 124a may be trained on a similar category of data or similar language, but may be from different vendors.

In one aspect, the pre-trained fallback embedding model 124a may be more complex in terms of parameters and embedding size than the main embedding model 122. For example, the embedding size (e.g. number of symbols) for the pre-trained fallback embedding model 124a can be 4 KB whereas for the embedding size for the main embedding model 124 can be 1 KB. In this case, the quality of restoring embeddings from the main embedding model 122 will be better.

The pre-trained fallback embedding model 124a is pre-trained by undergoing an initial phase of training on a large dataset to learn general patterns, features, and representations of the data. During pre-training, the pre-trained fallback embedding model 124a learns general-purpose representations that can be fine-tuned later for specific applications. For example, in language embedding models, pre-training may involve learning word relationships and contexts using vast corpora like books, websites, or articles.

The embedding transformation model 128 is trained using the input query 202, main embeddings 204 generated by the main embedding model 122, and the secondary embeddings 206 generated by the pre-trained fallback embedding model 124a to generate predicted main embeddings 208 for the main embedding model 124. As will be described in more detail in FIG. 3, the predicted main embeddings 208 are sent to the LLM service 210 when the main embedding model 124 is unavailable.

In some aspects, the embedding transformation model 128 may correspond to an auto-encoder. The auto-encoder in the embedding transformation model 126 operates as a neural network architecture designed for unsupervised learning, focusing on compressing and reconstructing data to manage dimensionality effectively. The autoencoder may have at least an encoder, latent space, and a decoder. The encoder compresses high-dimensional input embeddings into a lower-dimensional latent representation. It consists of neural layers that progressively reduce the dimensions while preserving the essential features of the input data. The compact, lower-dimensional representation lies in the latent space, where the most meaningful patterns and relationships in the data are captured. The decoder reconstructs the original data from the latent representation. It expands the lower-dimensional embeddings back into high-dimensional space by reversing the transformations applied by the encoder.

The auto-encoder may be trained using the original high-dimensional embeddings as input. The output from the decoder is compared to the original input. A reconstruction loss function (e.g., Mean Squared Error) measures the difference between the input and the reconstructed output, guiding the network to minimize this loss. The auto-encoder may be optimized by Using gradient descent or similar optimization algorithms, the auto-encoder adjusts its weights and biases to reduce reconstruction errors over successive training iterations.

The embedding transformation model 128 preserves key features due to the auto-encoder focuses on retaining the most relevant features of the data in the latent space, ensuring meaningful transformations. In addition, embedding transformation model 128 enables seamless conversion between high-dimensional and low-dimensional embeddings, adapting to various system requirements.

In this way, the embedding transformation model 128 may be trained while the main embedding model 122 and the trained fallback model are being executed.

FIG. 3 is a block diagram illustrating another aspect of operation of the system 100 for executing the embedding transformation model for generation of LLM embeddings when the main embedding model is unavailable according to aspects of the present disclosure. The method 300 describes an “emergency mode” scenario, where the embedding transformation model 128 is used to predict LLM embeddings based on the query 202 when the main embedding model 124 is offline or temporarily unavailable.

First, the method 300 includes determining that the main embedding model 124 is unavailable to generate main embeddings 204. The method 300 may include pinging the main embedding model 124 by using an API or health-check endpoint to confirm the operational status of the main embedding model 124 using the LLM service module 120. In other examples the LLM service module 120 may look for specific error codes (e.g., HTTP 500, 503) or responses indicating an issue with the main embedding model 124. Another example may be the LLM service module 120 running a simple test case for generating embeddings using the main embedding model 124. As another example, the LLM service module 120 may check network connectivity between the system requesting the embeddings and the server hosting the main embedding model 124.

Next, the method 300 includes generating secondary embeddings 206 using the pre-trained fallback embedding model 124a. Generating secondary embeddings 206 using the pre-trained fallback embedding model 124a involves leveraging an alternate, pre-trained model as a substitute for the main embedding model 124 when it is unavailable or fails to function. This process begins by ensuring that the pre-trained fallback embedding model 124a is pre-loaded or readily accessible within the system's environment. Since the pre-trained fallback embedding model 124a is a fallback model, it is typically designed to be lightweight and robust, capable of operating under conditions where the primary model might falter. The process entails passing the same input data intended for the main model (such as text, images, or other features) to pre-trained fallback embedding model 124a, which processes the input to generate embeddings. These embeddings serve as a representation of the input data in a lower-dimensional space, maintaining essential features and patterns.

To ensure consistency, the system might need to reconfigure preprocessing steps to align with the input requirements of the pre-trained fallback embedding model 124a. Additionally, if the output of the main embedding model 124 is fine-tuned for specific tasks, adjustments may be required to adapt the secondary embeddings for those tasks, potentially incorporating domain-specific transformations. Once generated, the secondary embeddings 206 can be stored, utilized for downstream applications, or passed to further stages of processing. This approach ensures continuity in operations, even in scenarios where the main embedding model 124 is unavailable, leveraging the fallback model's pre-trained capabilities to maintain system functionality.

The method 300 then includes applying the embedding transformation model 128 to the secondary embeddings 206 to generate predicted main embeddings 208 for the main embedding model based on the secondary embedding 206. For dimensionality reduction, during inference, the auto-encoder alone can be used to transform high-dimensional embeddings into the compact latent space, effectively reducing dimensionality. This is especially useful for storage and computational efficiency. For reconstructing high-dimensional data, during inference, the decoder can take the low-dimensional latent representation and reconstruct it into high-dimensional embeddings when detailed or enriched data is required for further processing.

During inference, the size of the input of the embedding transformation model 128 may be the same size as the output of the pre-trained fallback embedding model 124a and the size of the output of the embedding transformation model 128 may be the same size as the output of the main embedding model 124. Ensuring the size of the input of the embedding transformation model 128 matches the output size of the pre-trained fallback embedding model 124a during inference is a critical design choice that enables seamless processing and interoperability within the system. This alignment avoids dimensional mismatches that could otherwise introduce inefficiencies or degrade performance, ensuring smooth data flow and reducing latency. By maintaining consistent dimensions, the embedding transformation model 128 can focus on refining or adapting the embeddings for domain-specific or task-specific needs without the overhead of additional resizing operations. This consistency also simplifies the system architecture, eliminating the need for intermediary layers to handle dimensional adjustments, and preserves the semantic integrity of the embeddings by avoiding potential information loss. Furthermore, this design choice enhances the system's scalability, making it easier to upgrade or swap components in the future, as long as dimensional compatibility is maintained. Ultimately, this approach ensures robust, efficient, and high-quality performance during inference while streamlining both development and maintenance.

The method 300 then includes transmitting the predicted main embeddings 208 to the LLM service 210. Transmitting the predicted main embedding 208 to the LLM service 210 is a critical step that optimizes the integration of embeddings with large language models for enhanced performance. This refined and task-specific representation of input data ensures that the LLM receives high-quality, pre-processed input, improving its ability to generate accurate and context-aware outputs. By offloading much of the preprocessing work to the embedding generation pipeline, this step enables an efficient collaboration between system components, allowing the LLM to focus on higher-level reasoning and generation. The approach also enhances scalability and modularity by defining clear boundaries between components, making it easier to upgrade or replace elements like the embedding model or the LLM. Additionally, transmitting embeddings instead of raw input reduces computational overhead, leading to faster inference times and resource efficiency. This step encapsulates contextual and semantic information in a form the LLM can directly leverage, simplifying its task and improving its effectiveness in downstream applications such as semantic search, text generation, and conversational AI.

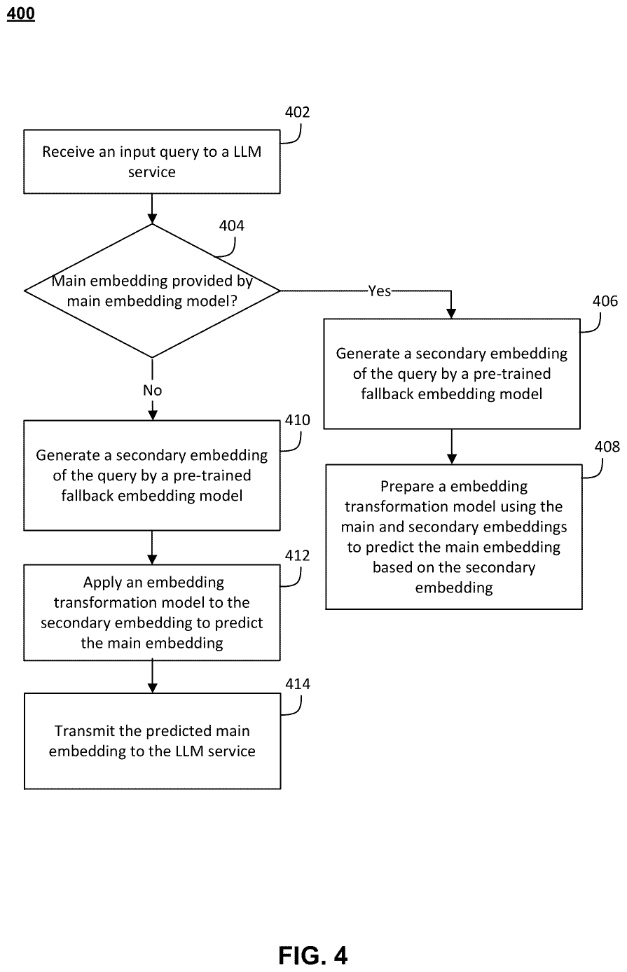

FIG. 4 is an example method for generating LLM embeddings according to aspects of the present disclosure. In various implementations, the method 400 is performed by a device with one or more processors and non-transitory memory that performs intent prediction. In some implementations, the method 400 is performed by processing logic, including hardware, firmware, software, or a combination thereof. In some implementations, the method 400 is performed by a processor executing code stored in a non-transitory computer-readable medium (e.g., a memory). The method 400 describes a method for training an embedding transformation model to predict a main embedding.

At 402, the method 400 includes receiving an input query to a LLM service.

At 404, the method 400 includes determining whether a main embedding of the query is provided by a main embedding model.

Based on a determination that the main embedding is provided by the main embedding model, at 406, the method 400 includes generating a secondary embedding of the query using a pre-trained fallback embedding model.

In some aspects, the pre-trained fallback embedding model is deployed on a client and the embedding transformation model is deployed on a server.

In some aspects, the main and secondary embeddings have different dimensionality. When main and secondary embeddings have different dimensionality, it means that the vector representations they produce to encode data, such as words, images, or other inputs, differ in the number of dimensions or features. This difference affects how data is represented, with higher-dimensional embeddings typically capturing more detailed or nuanced information, while lower-dimensional embeddings provide a more compact representation. However, this discrepancy can lead to compatibility issues, as systems expecting embeddings of a specific dimensionality may require resizing, truncation, or padding to align the vectors. Performance trade-offs also arise, with lower-dimensional embeddings offering faster processing and reduced memory usage but potentially less expressiveness, while higher-dimensional embeddings provide richer representations at a higher computational cost. Task performance can be impacted as well, as embeddings optimized for one dimensionality may require adaptation to perform effectively with another. Transformations like dimensionality reduction or projection into a shared space can help bridge these differences, but they add complexity. Additionally, comparing or interpreting embeddings of varying dimensionalities can be challenging, especially in tasks requiring consistent input dimensions. Addressing these differences is essential to maintain functionality and achieve desired performance across systems and tasks.

At 408, the method 400 includes preparing an embedding transformation model using the main and secondary embeddings to predict the main embedding based on the secondary embedding. Preparing an embedding transformation model that predicts main embeddings based on secondary embeddings is significant for ensuring compatibility and performance consistency in systems that rely on embeddings for downstream tasks. This approach enables the system to bridge the gap between embeddings with different dimensionalities or characteristics by learning a mapping from secondary embeddings to the space of the main embeddings. By doing so, it allows the system to leverage fallback models without compromising the performance or accuracy expected from the main model. This transformation model captures the relationships and patterns between the two embedding spaces, effectively translating the compact representation of secondary embeddings into the richer, more detailed main embedding space. This is particularly valuable in scenarios where the main embedding model is unavailable, as it allows the system to maintain continuity and seamlessly adapt to fallback embeddings while minimizing the impact on functionality and accuracy in downstream applications. Furthermore, such a transformation facilitates interoperability between different models and ensures that the system can operate robustly in diverse conditions, making it a critical component for systems with dynamic or multi-model architectures.

Based on a determination that the main embedding is not provided by the main embedding model, at 410, the method 400 includes generating a secondary embedding of the query using a pre-trained fallback embedding model. By proactively determining that the main embedding is not provided, the system seamlessly shifts to the fallback mechanism, leveraging a pre-trained model to generate embeddings that represent the input data. This ensures that critical operations relying on embeddings, such as similarity searches, recommendations, or classification, can proceed without interruption. The fallback model's pre-trained nature allows it to provide a robust and efficient alternative, maintaining reasonable performance and accuracy levels even in the absence of the primary model. This capability is particularly valuable in dynamic or fault-tolerant systems where service availability and reliability are paramount, allowing for graceful degradation rather than outright failure when the main model encounters issues.

In some aspects, the pre-trained fallback embeddings model is pre-trained on a similar type of data as the main embedding model. By using a similar data domain for pre-training, the fallback model is better equipped to generate embeddings that closely approximate the representations produced by the main model. This reduces the gap between the two embedding spaces, ensuring that the secondary embeddings remain meaningful and effective for downstream tasks. Such alignment minimizes potential performance degradation when switching to the fallback model, allowing for seamless integration into existing workflows or systems. Additionally, this similarity ensures that the fallback embeddings retain critical domain-specific patterns, relationships, and nuances required for the tasks at hand, thus enhancing the robustness and reliability of the overall system during periods of main model unavailability.

In some aspects, the pre-trained fallback embedding model comprises more complex parameters and embedding size than the main embedding model. This increased complexity enables the fallback model to capture subtle patterns and relationships, which can be crucial for tasks requiring nuanced understanding.

In some aspects, a size of an input of the embedding transformation model is a same size as an output of the pre-trained fallback embedding model. The alignment of the embedding transformation model's input size with the output size of the fallback model ensures that the transformation process can seamlessly process the fallback embeddings without truncation or additional preprocessing.

In some aspects, a size of an output of the embedding transformation model is a same size as an output of the main embedding model. Similarly, aligning the transformation model's output size with the main embedding model's output ensures compatibility with systems or applications that rely on embeddings of a specific size. Together, these aspects enable the embedding transformation model to act as a bridge, effectively translating the richer fallback embeddings into a format that mirrors the main embeddings, thereby preserving the system's performance and functionality even when relying on the fallback model.

In some aspects, the method 400 includes providing a plurality of fallback embedding models pre-trained on different types of data, wherein the different types of data correspond to different category of subject matter.

In some aspects, the method 400 may include determining a category of a subject matter of the input query; and selecting, out of a plurality of fallback embedding models, a model pre-trained on data associated with the determined category of the subject matter of the input query. In some aspects, the selection can be based on a type of MLM (e.g., generic), a particular language in the dataset, or dimensionality.

This approach enhances the adaptability and versatility of the system, allowing it to select the most appropriate fallback model based on the type of input data or the task at hand. By ensuring that each fallback model is pre-trained on data relevant to a particular category, the system can generate embeddings that better capture the nuances and features of that subject matter, leading to improved performance in domain-specific applications. This method is particularly valuable in scenarios where input data spans diverse categories, such as e-commerce, healthcare, or multimedia, as it ensures that fallback embeddings remain contextually relevant and semantically rich. Ultimately, this strategy boosts the system's robustness, enabling it to maintain high accuracy and effectiveness even when the main embedding model is unavailable.

In some aspects, the method 400 includes providing a training dataset comprising a plurality of main embeddings generated by the main embedding model for a set of input queries and a plurality of corresponding secondary embeddings generated by the pre-trained fallback embedding model for the same set of input queries; and pre-training the pre-trained fallback embedding model using the training dataset.

The significance of providing the training dataset comprising main embeddings generated by the main embedding model and corresponding secondary embeddings generated by the pre-trained fallback embedding model for the same set of input queries lies in establishing a robust foundation for the alignment and interoperability of the two models. By using the same set of input queries, the training dataset ensures that the embeddings generated by both models represent identical data points, enabling the system to capture relationships and correlations between the main and secondary embeddings. Pre-training the fallback embedding model with this dataset allows it to learn and mimic the representational patterns of the main embedding model, effectively narrowing the semantic and structural gap between their outputs. This alignment is crucial for creating a seamless transformation model or ensuring that fallback embeddings can directly substitute for main embeddings in downstream tasks. Overall, this approach enhances the fallback model's ability to generate embeddings that closely approximate the main embeddings, ensuring consistent performance and minimizing disruption in applications relying on these representations.

At 412, the method includes applying the embedding transformation model to the secondary embedding to predict the main embedding. This process enables the system to translate the secondary embedding into the space of the main embedding, preserving the semantic and structural characteristics needed for downstream tasks. By bridging this gap, the transformation model maintains the performance and accuracy of the system, even when relying on fallback embeddings, ensuring seamless operation and consistency across applications.

In some aspects, the embedding transformation model corresponds to an auto-encoder. An autoencoder is a type of artificial neural network used for unsupervised learning. It is designed to learn efficient, compressed representations of input data, often for dimensionality reduction or feature extraction. Autoencoders are typically used for applications such as data compression, denoising, anomaly detection, and pretraining other neural networks.

At 414, the method 400 includes transmitting the predicted main embedding to the LLM service. By providing the predicted main embedding, the system ensures that the input data is represented in a format the LLM service is optimized to process, maintaining consistency and performance across the workflow. This step allows the LLM service to leverage the semantic richness and structural properties of the main embedding, even when it was derived from a fallback embedding model and transformed via the embedding transformation model. As a result, the overall system achieves robust interoperability and accuracy, enabling effective downstream applications such as natural language understanding, text generation, or other LLM-powered tasks.

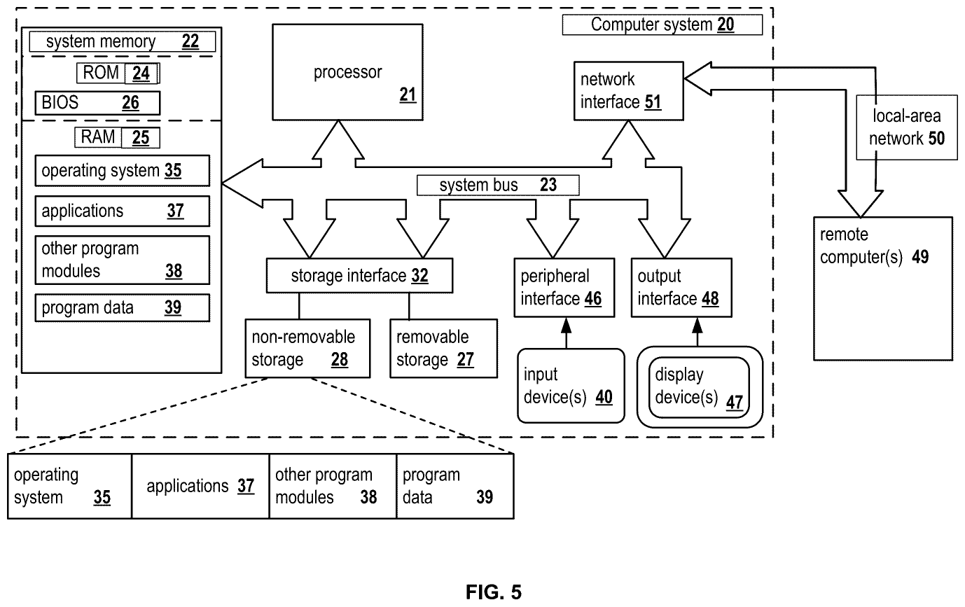

FIG. 5 is a block diagram illustrating a computer system 20 on which aspects of systems and methods for generating LLM embeddings may be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for generating LLM embeddings, comprising:
receiving an input query to a LLM service;
determining if a main embedding of the query is provided by a main embedding model; and
based on a determination that the main embedding of the input query is not provided by the main embedding model,
generating a secondary embedding of the query by a pre-trained fallback embedding model, and
applying an embedding transformation model to the secondary embedding to predict the main embedding and transmitting the predicted main embedding to the LLM service.

2. The method of claim 1, wherein the pre-trained fallback embedding model comprises more complex parameters and embedding size than the main embedding model.

3. The method of claim 1, wherein a size of an input of the embedding transformation model is a same size as an output of the pre-trained fallback embedding model.

4. The method of claim 1, wherein a size of an output of the embedding transformation model is a same size as an output of the main embedding model.

5. The method of claim 1, wherein the pre-trained fallback embeddings model is pre-trained on a similar type of data as the main embedding model.

6. The method of claim 5, further comprising:
determining a category of a subject matter of the input query; and
selecting, out of a plurality of fallback embedding models, a model pre-trained on data associated with the determined category of the subject matter of the input query.

7. The method of claim 1, wherein the main and secondary embeddings have different dimensionality.

8. The method of claim 1, further comprising:
providing a plurality of fallback embedding models pre-trained on different types of data, wherein the different types of data correspond to different category of subject matter.

9. The method of claim 1, wherein the pre-trained fallback embedding model is deployed on a client and the embedding transformation model is deployed on a server.

10. A system for generating LLM embeddings, comprising:
at least one memory; and
at least one hardware processor coupled with the at least one memory and configured, individually or in combination, to:
receive an input query to a LLM service;
determine if a main embedding of the query is provided by a main embedding model; and
based on a determination that the main embedding of the input query is not provided by the main embedding model, generate a secondary embedding of the query by a pre-trained fallback embedding model and apply an embedding transformation model to the secondary embedding to predict the main embedding and transmitting the predicted main embedding to the LLM service.

11. The system of claim 10, wherein the pre-trained fallback embedding model comprises more complex parameters and embedding size than the main embedding model.

12. The system of claim 10, wherein a size of an input of the embedding transformation model is a same size as an output of the pre-trained fallback embedding model.

13. The system of claim 10, wherein a size of an output of the embedding transformation model is a same size as an output of the main embedding model.

14. The system of claim 10, wherein the pre-trained fallback embeddings model is pre-trained on a similar type of data as the main embedding model.

15. The system of claim 14, wherein the at least one hardware processor is further coupled with the at least one memory and configured, individually or in combination, to:
determine a category of a subject matter of the input query; and
select, out of a plurality of pre-trained fallback embedding models, a model pre-trained on data associated with the determined category of the subject matter of the input query.

16. The system of claim 10, wherein the main and secondary embeddings have different dimensionality.

17. The system of claim 10, wherein the at least one hardware processor is further coupled with the at least one memory and configured, individually or in combination, to:
provide a plurality of pre-trained fallback embedding models pre-trained on different types of data, wherein the different types of data correspond to different category of subject matter.

18. The system of claim 10, wherein the pre-trained fallback embedding model is deployed on a client and the embedding transformation model is deployed on a server.

19. A non-transitory computer readable medium storing thereon computer executable instructions for generating LLM embeddings, including instructions for:
receiving an input query to a LLM service;
determining if a main embedding of the query is provided by a main embedding model; and
based on a determination that the main embedding of the input query is not provided by the main embedding model, generating a secondary embedding of the query by a pre-trained fallback embedding model and applying an embedding transformation model to the secondary embedding to predict the main embedding and transmitting the predicted main embedding to the LLM service.

20. The non-transitory computer readable medium of claim 19, wherein the pre-trained fallback embeddings model is pre-trained on a similar type of data as the main embedding model.
